(19) United States
(12) Patent Application Publication
(10) Pub. No.: US 2015/0346483 A1
(43) Pub. Date: Dec. 3, 2015

(54) FLAT-FIELD SCANNING LENSES, SYSTEMS, AND METHODS

(71) Applicant: Jonathan S. Ehrmann, Sudbury, MA (US)

(72) Inventor: Jonathan S. Ehrmann, Sudbury, MA (US)

(21) Appl. No.: 14/726,443

(22) Filed: May 29, 2015

Related U.S. Application Data
(60) Provisional application No. 62/005,101, filed on May 30, 2014.

(51) Int. Cl. G02B 26/10; G02B 7/10; B23K 26/06; G02B 15/14

(52) U.S. Cl. CPC G02B 26/101; G02B 15/14; G02B 7/10; B23K 26/0648

(57) ABSTRACT

Flat-field laser scanning lenses, systems, and methods with configurable focal length provide focus height accommodation. Lens elements are located by group at respective positions. Focal length configuration may be fixed, may be set, and may be adjusted. Systems include one or more beam deflectors configured to receive an input beam and deflect the input at scan angles, and a controller configured to generate scanning commands. The controller may be responsive to lens adjustments to direct the scanned beam to predetermined points in the scan field at multiple focus height settings. Methods include adjusting the focus height of a laser processing system with a lens focal length adjustment, and may include scaling scanning position commands to correlate commanded scan field positions with scan field positions at a focus height, adjusting the lens focal length in response to a sensor input, and sequentially focusing the lens at multiple workpiece heights.

### CROSS-REFERENCE TO RELATED APPLICATIONS

This application claims the benefit of U.S. provisional application Ser. No. 62/005,101, filed May 30, 2014, entitled “FLAT-FIELD SCANNING LENSES, SYSTEMS, AND METHODS.”

### BACKGROUND OF THE INVENTION

The field of the invention is deflection based flat-field laser scanning.

Lasers are widely used in a variety of material processing applications with optics to focus the laser beam to a spot at the workpiece. Many laser processing systems employ optical scanners to direct the laser beam to locations within a scan field at high speed. Some optically scanned material processing systems, for example certain laser marking and micromachining systems, utilize rotating mirrors mounted on galvanometers (galvos) for high-speed precision laser scanning. A pair of galvos is mechanically mounted into a scan head to deflect the beam in two axes. Typically, a controller associated with the scan head is used to generate analog or digital positioning signals that control the galvo angles and resulting mirror rotation to direct the beam to positions in the scan field.

These galvo-based systems typically use optics such as pre-objective scan lenses or post-objective scan lenses when a focused spot is required. FIGS. 1A and 1B show the basic configurations of pre-objective and post-objective scanning respectively. Referring to FIG. 1A, the pre-objective type deflects an input laser beam with scan head 100 before it impinges scan lens objective 101. Then, after deflection by scan head mirrors, the objective directs the beam to x and y axes coordinate locations in the scan field and at the same time the objective focuses the laser to a spot in the scan field. F-theta lenses are a well-known class of flat-field pre-objective scan lenses that form a spot in a flat scan field at a position such that the position of the laser spot in the field is proportional to the input scan angle. The f-theta lenses are well-suited for use with small aperture galvo mirrors, and can form a compact high-speed beam positioning system. Unfortunately, f-theta lenses are generally fixed focus lenses with no provision for focus accommodation to vary the distance from scanners to the scan field.

In a different optical arrangement, Referring to FIG. 1B, post-objective scan lens systems deflect the beam with rotating scan head mirrors of scan head 100 after the beam exits upstream focusing optics 102. This arrangement is well-suited to larger beam diameters where f-theta lenses become relatively costly and complex. To focus on a flat field, post-objective systems use some form of dynamic focusing to accommodate focus distance changes at different positions in the scan field. Utilizing predetermined scan head geometry and scan field locations, dynamic focusing can be controlled to flatten the scan field of the post-objective system. With a dynamic focus z-axis in addition to x and y field scanning, the post-objective system is known as a 3-axis system, deflecting the beam in the x-axis, the y-axis, and dynamically focusing along the z-axis. Dynamic focusing usually relies on mechanical lens translation. Translation speeds are slow when compared with high-speed galvo beam deflection speeds, so post-objective dynamic focusing is not well-suited to high-speed scanning.

Considering pre-objective and post-objective scanning approaches, in particular the fixed focus nature of f-theta lenses and the slow focusing of dynamic focusing mechanisms, there remains a need for improved flat-field scanning lenses, systems, and methods.

### BRIEF SUMMARY OF THE INVENTION

The present invention is directed to laser scanning lenses, systems, and methods in which flat-field scan lenses with configurable focal length provide focus height accommodation. The invention provides a range of configurable focal lengths with Variable Focus Flat Field lenses (also referred to as VF³ lenses). A scanned input beam is received by a VF³ lens and focused in a scan field at a focus height associated with the configurable VF³ lens focal length.

Among many aspects, the present invention is directed to VF³ lenses configured to receive an angularly scanned laser beam and focus the scanned laser beam in a scan field at a focus height. Multiple lens elements are located along an optical axis including one or more configurable lens element group. Configurable lens elements are located by group at respective positions that correspond to a VF³ lens focal length configuration. Focal length configuration may be fixed at a first focal length, may be set to a first focal length, and may be adjusted to a first focal length. Adjustment may employ an adjustment mechanism actuated manually or motorized with a controller configured to adjust VF³ lens focal length. A control signal interface responsive to remote commands may be included. Focal length may be configured to focus an auxiliary beam having a second wavelength at a common focus height with the scanned laser beam having a first wavelength.

Also among many aspects, the present invention is directed to VF³ lens based beam directing systems that include one or more beam deflectors configured to receive an input beam and deflect the input at scan angles corresponding to locations in a scan field, a VF³ lens configured to receive the scanned input beam and focus the beam in a scan field at an adjustable focus height setting, and a controller configured to generate scanning commands to direct the scanned beam to predetermined points in the scan field. The controller may be responsive to VF³ lens adjustments and configured to output scanning commands to direct the scanned beam to predetermined points in the scan field at multiple focus height settings. The focused beam may form a laser spot with a laser spot size that is correlated with focus height.

Also among many aspects, the present invention is directed to laser processing methods that include the steps of adjusting the scan field focus height of a laser processing system with a VF³ lens focal length adjustment and processing material in the scan field at a first focus height. The methods may further include adjusting the VF³ lens focal length to a second focal length setting, and processing material at a second focus height. The methods may include scaling scanning position commands to correlate commanded scan field positions in the scan field at a first focus height with scan field positions at a second focus height, adjusting the diameter of a laser beam input to adjust the focused laser spot size in accordance with a VF³ lens focal length setting, adjusting the VF³ lens focal length in response to a sensor input, and sequentially focusing the VF³ lens at multiple workpiece heights in an addressable scan volume and processing workpiece material at multiple heights within the scan volume. Processing at multiple heights may include processing material layer-by-layer, at multiple levels, on tilted surfaces and on topographical contours. Laser parameters and other laser processing system component parameters may be adjusted cooperatively with the VF³ lens focal length setting.

Various objects, features, aspects, and advantages of the present invention will become more apparent from the following detailed description of preferred embodiments of the invention, along with the accompanying drawings.

### BRIEF DESCRIPTION THE DRAWINGS

FIG. 1A is 3-dimensional view of pre-objective scanning (prior art);

FIG. 1B is 3-dimensional view of post-objective scanning (prior art);

FIG. 2A is a graph of catalog f-theta lens beam diameter versus focal length;

FIG. 2B is a graph of catalog f-theta lens count versus focal length;

FIG. 3A is a diagram that illustrates a variable focal plane distance;

FIG. 3B is a diagram that illustrates a focus range relative to a fixed workpiece;

FIG. 4 is a diagram that illustrates multiple scan field formats;

FIG. 5 is a diagram that illustrates lens group positioning in a lens;

FIG. 6 is a view showing features of a VF³ lens;

FIG. 7 is a view showing features of a VF³ lens;

FIGS. 8A-8C are cross sectional layout views of lens elements at three focal length configurations of a four element VF³ lens optical design;

FIGS. 9A-9C are cross sectional layout views of lens elements at three focal length configurations of a five element VF³ lens optical design;

FIGS. 10A-10C are cross sectional layout views of lens elements at three focal length configurations of a five element VF³ lens optical design;

FIGS. 11A-11C are cross sectional layout views of lens elements at three focal length configurations of a six element VF³ lens optical design;

FIG. 12 is a diagram that illustrates scan angle scaling with field height;

FIG. 13 is a block diagram of a VF³ lens and scan control architecture;

FIG. 14 is a flow chart showing a scan job with scaled coordinate data;

FIG. 15 is a block diagram of a VF³ lens and scan control architecture with a distance sensor;

FIG. 16 is a block diagram of a VF³ lens and scan control architecture with an internal illuminator and external optical sensor;

FIG. 17A is a block diagram of a VF³ lens and scan control architecture with an internal illuminator and internal optical sensor;

FIG. 17B is a block diagram of a VF³ lens and scan control architecture with an external illuminator and internal optical sensor;

FIG. 18 is a block diagram of a VF³ lens and scan control architecture with an external surface topography sensor

FIG. 19 is a diagram that illustrates focus steps and VF³ lens settings;

FIG. 20 is a diagram that illustrates a tilted field and VF³ lens adjustment;

FIG. 21A is a block diagram of a VF³ lens based system;

FIG. 21B is a block diagram of a VF³ lens based system with topography sensing;

FIG. 21C is a block diagram of a VF³ lens based system with target imaging and illumination;

FIG. 21D is a block diagram of a VF³ lens based system with process monitoring;

FIG. 22 is a diagram that illustrates aspects of spot size control;

FIG. 23 is a diagram that illustrates volumetric scanning with a VF³ lens.

### DETAILED DESCRIPTION OF THE INVENTION

Before the present invention is described in further detail, it is to be understood that the invention is not limited to the particular embodiments described, as such may, of course, vary. It is also to be understood that the terminology used herein is for the purpose of describing particular embodiments only, and is not intended to be limiting, since the scope of the present invention will be limited only by the appended claims.

### Fixed Focal Length Lenses

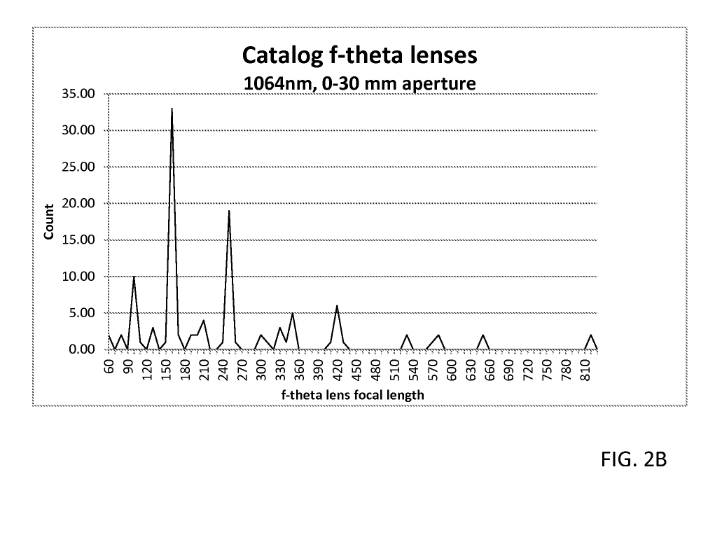

Pre-objective and post-objective scan optics are widely available for various laser scanning applications. The pre-objective system typically features a fixed focal f-theta lens or other fixed flat-field lens. Many such lenses are readily available in certain wavelength, aperture, field angle and focal length configurations from a variety of suppliers. FIG. 2A shows a scatter graph of maximum entrance beam diameter versus focal length for some catalog fixed format f-theta lenses at a 1064 nm wavelength. For a particular processing application, a user might select from these or similar lenses to implement a particular scan field format. FIG. 2B shows the number of these lenses plotted by focal length and to illustrate some commonly available fixed focal length formats (e.g. 100, 160 and 254 millimeters).

However, in some cases, the workpiece height varies and focus errors exceeding the available depth of focus of fixed focal length pre-objective scan optics can result. Additional focusing features can be employed to maintain fine focus include moving the target surface into the focal plane, moving the entire scan head or processing system relative to a fixed target, or changing the input collimation to the scan head by adjusting an upstream focusing optic. A fixed focal length pre-objective lens may be translated axially for focus, but this moves the entrance pupil of the lens relative to the scan head mirrors and may degrade optical performance.

### Variable Focus Flat-Field Lenses

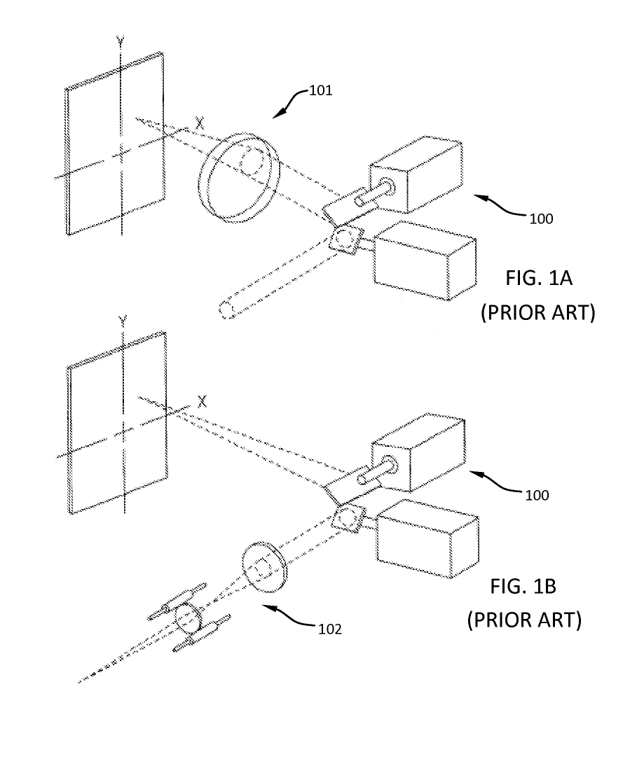

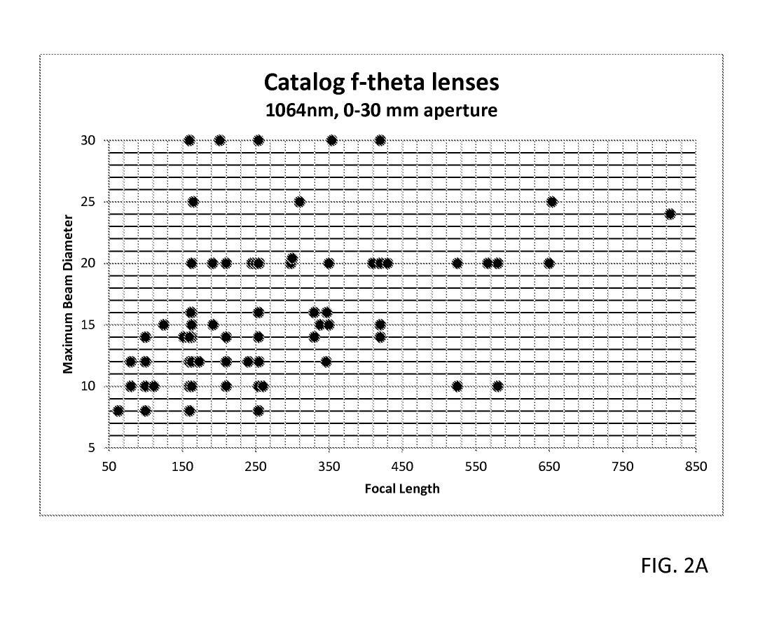

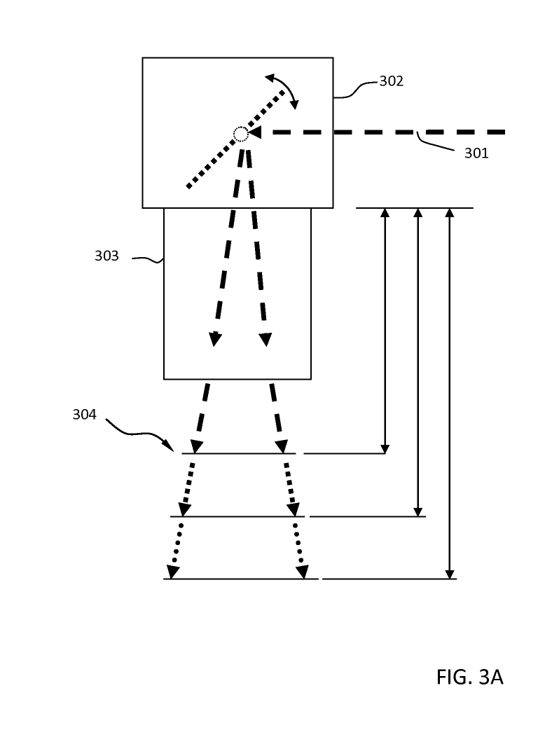

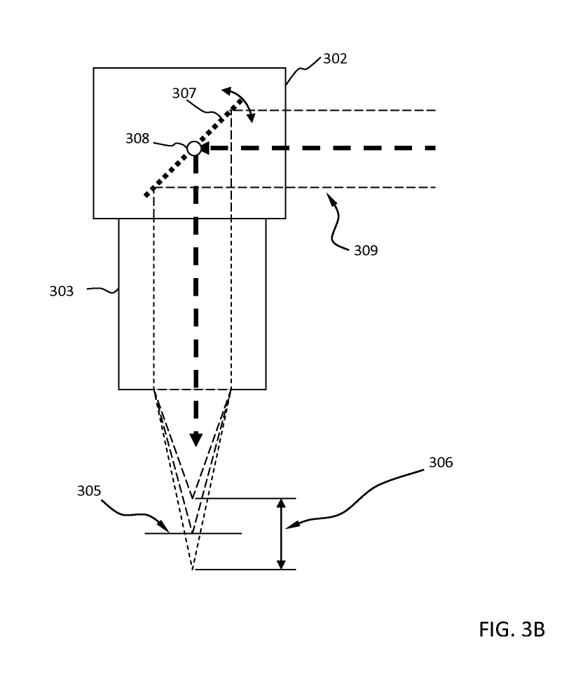

Advantageously, VF³ lens embodiments of the present invention with adjustable focal length provide variable focus height and thus improve on fixed f-theta lenses by accommodating workpiece height variations from a nominal focus height with corresponding changes in the VF³ lens focal length. As show in FIG. 3A, input beam axis 301 is deflected by a scan head 302 into VF³ lens 303. As the focal length of VF³ lens 303 changes, distance from scan head 302 to focal plane 304 changes to achieve focusing. As shown in FIG. 3B, a workpiece surface can remain at a fixed height 305 as the VF³ lens 303 focal length is set within in focusing range 306. Scan head 302 can remain fixed relative to the workpiece, scan mirrors 307 remain at the design entrance pupil 308 of the VF³ lens, collimation of input 309 is maintained, and adjustment of optional upstream beam conditioning optics for focus, for example adjusting focusing beam expanders for focus is not required. It is noted that while numerous drawing figures herein may show a single scan mirror for convenience, it is to be understood that this mirror representation is a schematic representation that includes single-axis scanning as well as x-axis and y-axis scan mirrors of a two-axis scan head, for example scan head 100 in FIG. 1A.

VF³ lens embodiments with focusing capability have advantages relative to post-objective dynamic focusing systems. Dynamic focusing speeds of post-objective subsystems (e.g. translating z-axis lens speed), may be slower than maximum scan head beam deflecting speeds. Conveniently, a VF³ lens adjustment can provide fine focus of a flat scan field without a dynamic field flattening z-axis lens. As a result, a VF³ lens can provide flat-field scanning at higher scan head deflection speeds. This is of particular interest with faster scanning smaller scan head apertures, for example apertures at or below 20 mm.

Another advantage of VF³ lenses relative to post-objective dynamic focusing systems is reduction of the incident angle of the beam axis to the workpiece. The incident angle is a result of the compound scan angle intercepting the target plane relative to the surface normal and represents a departure from the telecentric condition. This incident angle elongates the laser spot on the workpiece generating an elliptical spot with an increased area that reduces laser fluence. VF³ lenses reduce the incident angle when compared with dynamic-focus post-objective systems, and this helps limit the telecentricity error effects of high incident angles and spot elongation. Relative to post-objective systems, VF³ lenses may reduce the incident angle by about 40%, for example from 25 degrees to 15 degrees at the extreme corner of a scan field. This incident angle reduction may reduce telecentricity errors approximately 40% and spot elongation from about 10% to 3.5%.

Now considering fixed f-theta lenses, as mentioned above, a selection of f-theta lenses at certain field size and spot size formats is available from multiple laser optics catalogs. An available scan field format may be chosen for a first processing job with by selecting a first f-theta scan lens with a first focal length and mounting the first lens for running the first processing job. Then for a second processing job, a second format may be chosen by selecting a second f-theta scan lens with a second focal length. A format change can be accomplished by removing the first scan lens and replacing it with the second scan lens for the second processing job.

For example, a 160 mm focal length objective may be used to scan within a 100 mm square field. The 160 mm is removed and replaced with a 254 mm objective to scan within a 160 mm square field. In this example, two fixed lenses are required, one for each of two different formats. Thus, not only is the user limited to the two formats, but the user must maintain multiple lenses and physically handle multiple lenses to make the format change. For each additional desired format, an additional fixed scan lens is required.

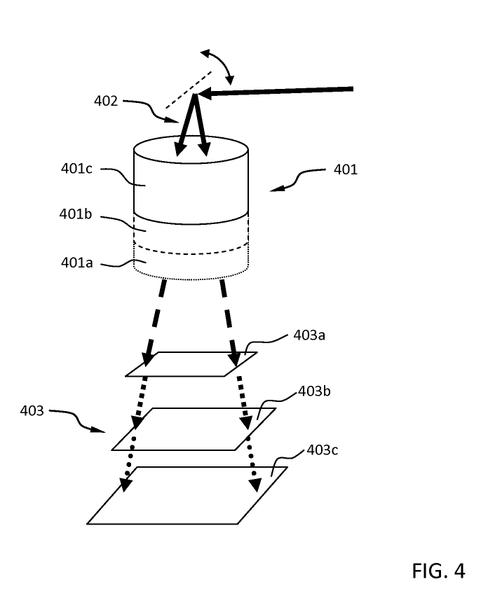

When compared to fixed f-theta lenses, adjustable VF³ lens embodiments provide significantly increased capability providing multiple formats in a single adjustable lens. Advantageously, an adjustable VF³ lens can replace two or more fixed focal length lenses and eliminate the need for lens changes, lens inventory, and lens handling. Referring to FIG. 4, VF³ lens 401 receives deflected input beam 402 and directs the deflected beam to points in scan field 403. Scan field size is quickly changed between different formats 403a, 403b and 403c with respective lens focal lengths adjustments 401a, 401b, and 401c. Generally, field size in respective scan formats is proportional to the respective focal length setting.

In some embodiments, a VF³ lens is configured with discrete focal length settings, end stops, detents or the like corresponding to a set of predetermined focal lengths including maximum and minimum focal length values. In other embodiments, a VF³ lens is configured with continuous adjustment, providing finely resolved intermediate focal lengths between maximum and minimum focal length values. With continuous adjustment, not only are multiple standard formats available in one lens, but intermediate focal lengths are available that would otherwise require a custom fixed focal length lens design. With an adjustable VF³ lens, finely resolved focal lengths can be supplied on demand to suit a variety of processing requirements.

It can be appreciated that handling scan lenses and optical elements presents opportunity for lens contamination, lens damage and lens placement errors. Moreover, lens changeovers present potential exposure of internal scan head and scanning subsystem optical surfaces to contamination. Advantageously, in at least one VF³ lens embodiment, the format is changed without a lens changeover. Thus, VF³ lenses minimize and potentially eliminate the risks of damage, contamination and placement errors associated with lens changeovers.

Additional benefits are achieved when a VF³ lens is used and lens changeovers are eliminated. For example, removing and replacing scan lenses to achieve multiple formats may take several minutes and slow processing or render laser processing impossible due to the time required for the lens changeover. Other potential problems associated with lens changeover are time needed for warm-up of the system after a format change and potentially scan field recalibration. Conveniently, in at least one embodiment, a VF³ lens can be manually adjusted in a few seconds or tens of seconds to help maintain workflow. In some cases, with motorized lens adjustment, a VF³ lens may be adjusted to reconfigure the scan field format in less than one second. With fast adjustments, the VF³ lens achieves multiple scan field formats with minimal system disruption.

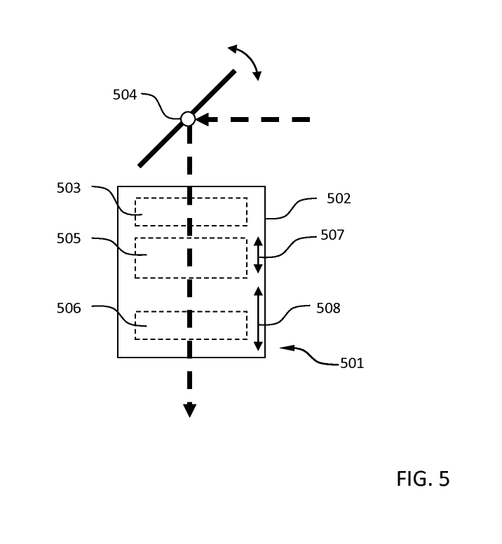

As shown in FIG. 5, a VF³ lens 501 comprises one or more lens group that can be positioned in lens housing 502 to configure the focal length of the VF³ lens. In this example, the first lens group 503 is stationary and maintains a constant distance from scan head mirror axis 504. The second and third lens groups 505, 506 are positioned along the optical axis of the scan lens within respective positioning ranges 507 and 508 to locate lens elements by group and configure the focal length. Generally, the positioning range for each group will depend on the desired overall focal length range and constraints on maximum lens length.

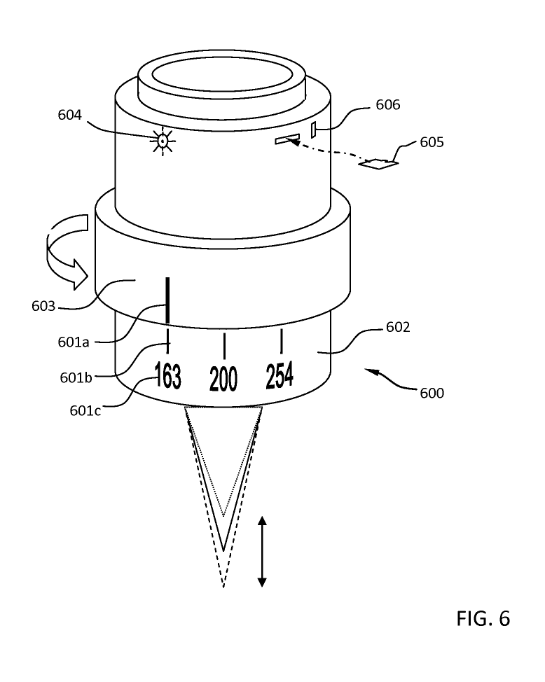

In VF³ lens embodiments with incremental or continuous focal length adjustment, some form of indicia may be useful for identifying the current setting of a VF³ lens. For example, as shown in FIG. 6, a VF³ lens 600 may be provided with indicia 601a, 601b, 601c on lens barrel 602 and on focus actuation ring 603 to indicate a lens focal length setting. A VF³ lens may provide visible or audible status indications of a lens setting such as focal length, focus distance, field size or other status, for example with one or more status LED 604.

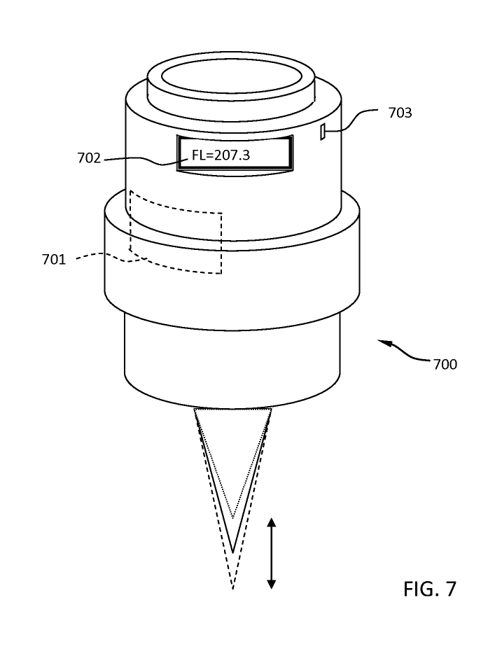

Referring to FIG. 7, in some adjustable embodiments a VF³ lens 700 may be provided with sensing element 701, for example a position detector or encoder, to generate lens setting control signals. In particular, the lens setting signal corresponds with the current lens and is used for graphical display of lens setting data 702 (e.g. focal length, focus distance, field size) or for communication of lens setting data, for example via data port 703. In at least one embodiment, an embedded microcontroller reads a sensing element and generates a control signal based on lens focal length. With a lens based graphical display, data type for display may be selectable from a predetermined list.

VF³ lens embodiments may be characterized by a maximum focal length adjustment range ratio with diffraction limited performance, or with other predetermined performance criteria. The maximum to minimum focal length range ratio will depend on laser wavelength, input beam diameter, maximum scan field angles, working distance constraints, system constrains, and scan head geometry. One focal length adjustment range ratio is 1.3× or less, for example 80-100 mm, 160-200 mm, 200-254 mm or 254-330 mm. Another range ratio is approximately 1.6×; for example 100-160 mm and 163-254 mm. Yet another range ratio is greater than 2.5×, for example 100-254 mm and 160-420 mm. The input beam diameter may be in the range of 7 mm to 20 mm and correspond with commercially available scan heads. Generally, small ranges are associated with simpler lens designs or smaller spot sizes, and are suited to fine focusing applications. Larger ranges are associated with more complex lens designs or larger spot sizes and are suited to long focusing ranges and multiple field size formats.

The table below shows some contemplated combinations of input aperture and focal length range for multiple format 1064 nanometer VF³ lenses corresponding with common scan head apertures.

| FL mm\input mm | 7 | 10 | 10 | 14 | 20 |
|---|---|---|---|---|---|
| 100 | ✓ | | ✓ | | |
| 160 | ✓ | ✓ | ✓ | | |
| 163 | ✓ | ✓ | | ✓ | |
| 254 | ✓ | ✓ | | ✓ | ✓ |
| 330 | | ✓ | | | ✓ |
| 420 | | ✓ | | | |

Specific focal length ranges of VF³ lenses optimized at other wavelengths in a range of IR, visible and UV fundamental and frequency multiplied laser wavelengths, for example 1030 nm, 532 nm or 355 nm may have different focal length ranges. Generally, VF³ lenses optimized at shorter wavelengths will have smaller focal length ranges.

Many scan lenses are designed for a single laser output wavelength, but some laser processing applications also use an alternate wavelength. For example, alternate wavelengths used in conjunction with VF³ lenses may be generated in alternate laser sources for processing, multiple output wavelength laser sources, laser designation and pointing sources, or illumination sources for through-the-lens viewing of the target. Unfortunately, with a single wavelength scan lens design, uncorrected axial chromatic aberration can shift the focus of the alternate wavelength away from the nominal focus. Multi-wavelength color corrected scan lens designs can correct the axial chromatic aberration focus shift, but these lenses require more complex achromatized design. Advantageously, in at least one embodiment of the invention, an adjustable VF³ lens is optimized for multiple wavelengths and VF³ lens adjustment is used to sequentially focus multiple wavelengths at a nominal focus plane. Residual lateral chromatic aberration can be corrected with wavelength specific scan field calibration.

Multi-wavelength embodiments can be implemented using lens group positioning rather than color correcting elements. However, VF³ lens embodiments with color correcting elements, configured to operate at multiple wavelengths are considered to be within the scope of the present disclosure. Color correcting elements may be used in VF³ lenses to simultaneously correct axial color at multiple wavelengths. With color correcting elements, VF³ lens focal length adjustment is used to simultaneously adjust the focus of multiple wavelengths.

Focused laser spot size is generally of paramount interest in laser processing applications and preferably VF³ lenses are diffraction limited for generating small uniform spots. For example, a VF³ lens may be corrected (i.e. corrected optical aberrations) to generate laser spots with Strehl ratios of 0.7 or higher at different focal length settings and at positions across the scan field at each setting. Other criteria may include wavefront OPD of less than ¼ wave peak-to-peak or OPD less than 0.07 waves RMS. Some processing applications may require even higher levels of correction for example 0.05 waves RMS. At higher levels of correction, focus ranges and field sizes of VF³ lens embodiments described may be reduced.

Preferably a VF³ lens accepts scan head beam deflection angles of +−20 degrees optical and images a laser spot in a square scan field. At extreme focal length settings, for example at the short focal length settings, reduced field sizes may be used to extend the focal length range of the VF³ lens. Also, VF³ lens designs may use scan angles less than 20 degrees with square fields or used round field formats to reduce component optical element size and cost as well as to reduce lens complexity, e.g. using fewer component lenses or using fewer lens group adjustments.

Often small laser spots are desired, but in some cases spot size enlargement is needed. Conveniently, adjustable VF³ lenses embodiments provide spot defocus capability directly by changing the focal plane axial position relative to the target workpiece. The further the beam waist is moved, the larger the effective spot size which can be calculated by using Gaussian beam propagation equations. In this way spot enlargement can be achieved without modification to input beam diameter or collimation.

Generally, a VF³ lens will be more complex than a fixed focal length f-theta lenses with similar focal lengths and apertures. For example a VF³ lens may have 4 or more optical elements resulting in 8 or more optical surfaces. With more optical surfaces, optical losses may be increased relative to simpler optical designs (e.g. 3 elements). Optical efficiency of a lens will depend in large part on lens surface optical coatings. Preferably efficient anti-reflection coatings such as V-coatings with reflectivity below 0.25% are used on all optical surfaces of a VF³ lens to maximize lens transmission efficiency. Use of alternate wavelengths may indicate the use of double band or broadband coatings.

The damage threshold of each coating should accommodate the incident laser parameters as well as any internal images generated by primary surface reflections. In some cases, deflector mirror coatings and other optical material in or adjacent to the optical beam path may be susceptible to laser damage from internal images resulting from internal reflections. For high power applications, selected focal length settings may be excluded based on analysis of reflections and internal image locations to avoid laser damage.

A VF³ lens may be optimized to ensure that back reflection (i.e. narcissus) image surfaces through the adjustment range do not intercept mirror surfaces or other optical damage prone optical surfaces. Control of back reflected images using ray tracing techniques may locate back reflected images between lens elements, between an output scan mirror and a first lens surface, between first and second scan mirrors and before a first scan mirror. As a result, in some cases the adjustment range may be limited to a fine focus range of 10% or less of the lens track length. For example a VF³ lens with controlled back reflection may have a focal length range from 242 mm to 266 mm and a focus range of 25 mm.

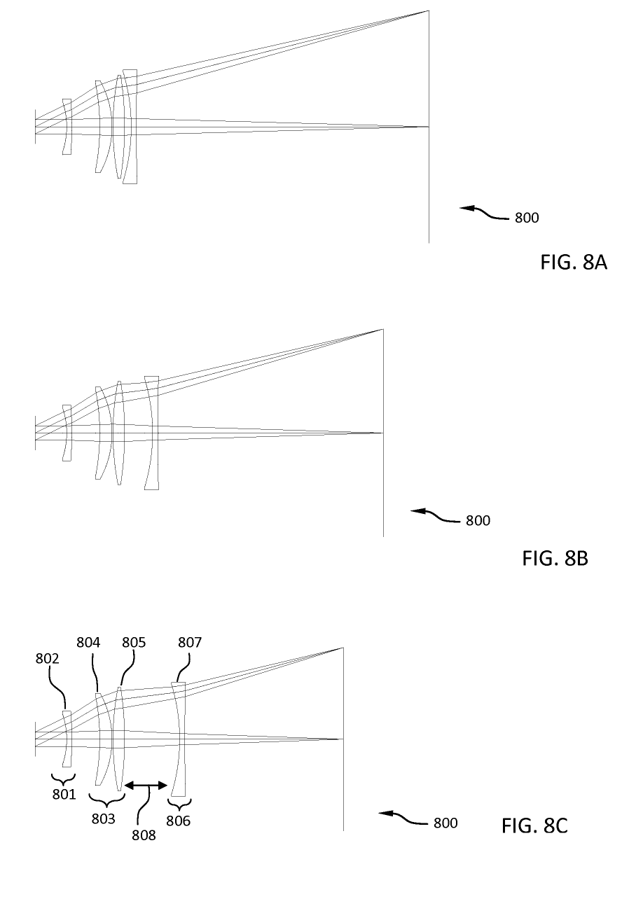

In one embodiment, a four element VF³ lens 800 having a focal length range of 200 mm to 254 mm at 1064 nm with a 14 mm input aperture is shown with different focal length configurations in FIG. 8A-FIG. 8C. Referring to FIG. 8C, from the input surface to the output surface, VF³ lens 800 comprises three lens groups. A first lens group 801 is a single fixed N-BK7 element 802 concave toward the input having negative optical power. A second lens group 803 comprises at least two N-SF6 elements 804, and 805, each element having positive optical power, the second group is fixed. A third group 806 is a single N-BK7 element having negative optical power configured to be adjusted along the optical axis. Motion away from the first group decreases focal length of the VF³ lens. Preferably, the second group comprises two optical elements. The focus range may be approximately 84 mm and the square field size may be 125 mm to 160 mm.

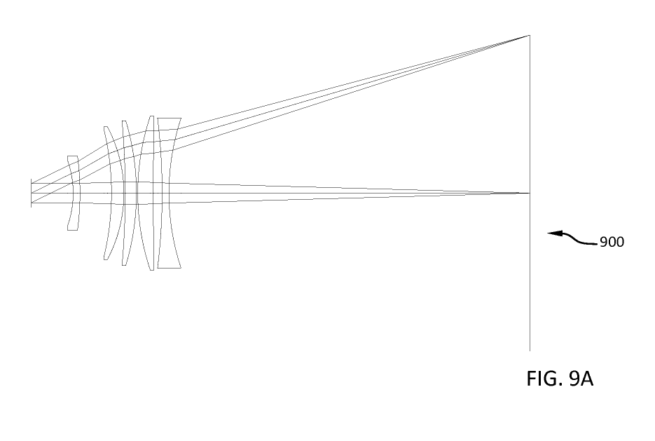

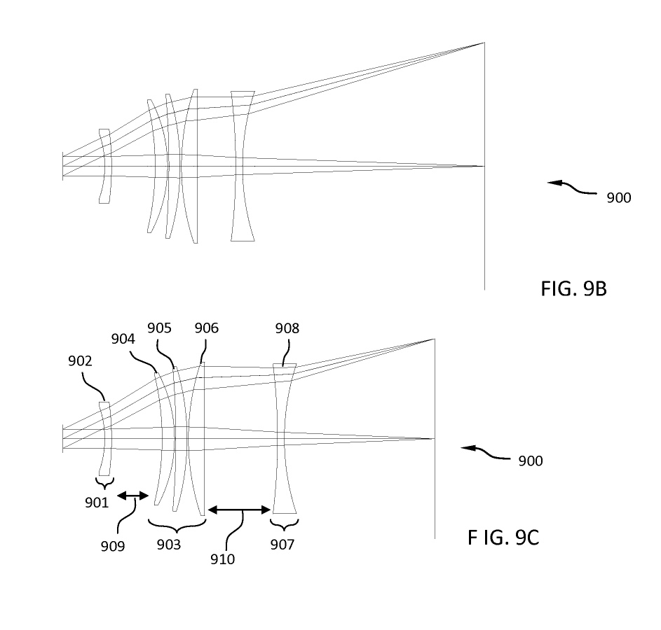

In one embodiment, a five element VF³ lens 900 having a focal length range of 163 mm to 254 mm at 1064 nm with a 14 mm input aperture is shown with different focal length configurations in FIG. 9A-FIG. 9C. Referring to FIG. 9C, from the input surface to the output surface, VF³ lens 900 comprises three lens groups. A first lens group 901 is a single N-BK7 fixed element 902 concave toward the input having negative optical power. A second lens group 903 comprises multiple N-SF6 elements 904, 905, and 906, each element having positive optical power, the second group configured to be adjusted along the optical axis. A third group 907 is a single N-BK7 element 908 having negative optical power configured to be adjusted along the optical axis. Motion of the third group 907 away from the first group decreases focal length of the VF³ lens. Motion of the second group 903 provides well-corrected optical aberrations over a wide focal length adjustment range. Preferably, the second group comprises three optical elements as shown. The focus range may be approximately 93 mm and the square field size may be 100 mm to 160 mm. In an alternate configuration the first group may further comprise a second element after the first negative power element. In another alternate configuration the third group may have two elements and negative optical power. In yet another alternate configuration the second group may have positive optical power and comprise three or more optical elements.

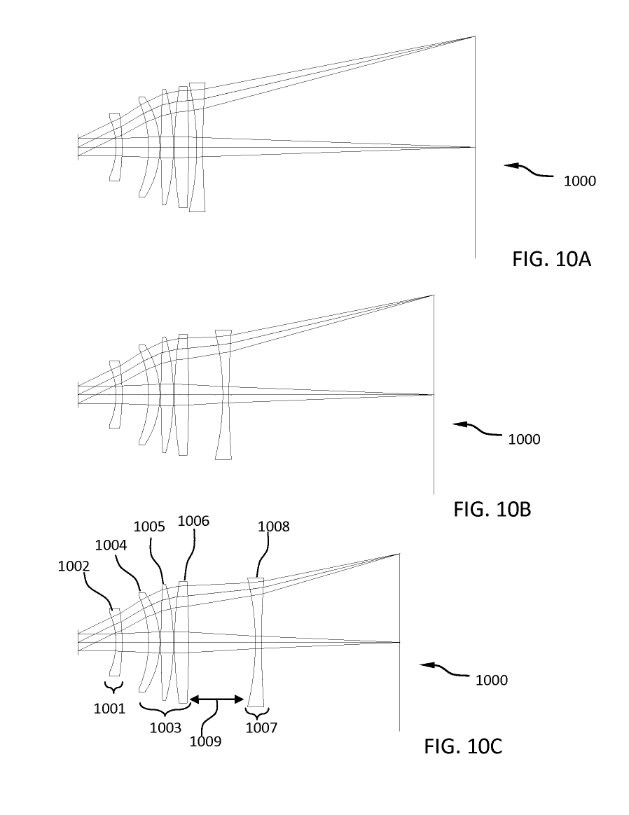

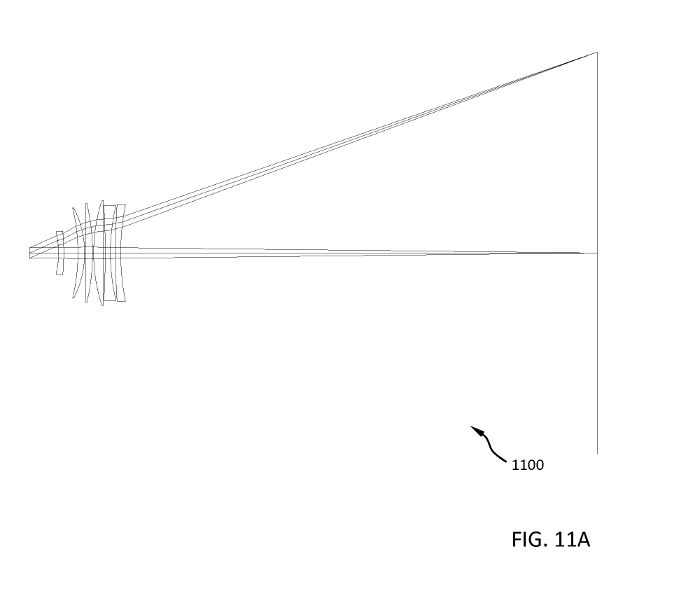

In one embodiment, a 5 element VF³ lens 1000 having a focal length range of 160 mm to 200 mm at 1064 nm with a 14 mm input aperture is shown with different focal length configurations in FIG. 10A-FIG. 10C. Referring to FIG. 10C, from the input surface to the output surface, VF³ lens 1000 comprises three lens groups. A first lens group 1001 is a single N-BK7 fixed element 1002 concave toward the input having negative optical power. A second lens group 1003 comprises at least two N-SF6 elements 1004, and 1005, each element having positive optical power, the second group fixed along the optical axis. A third group 1007 is a single N-BK7 element having negative optical power configured to be adjusted along the optical axis. Motion away from the first group decreases focal length of the VF³ lens. Preferably, the second group comprises three optical elements including element 1006. The focus range may be approximately 61 mm and the square field size may be 100 mm to 125 mm.

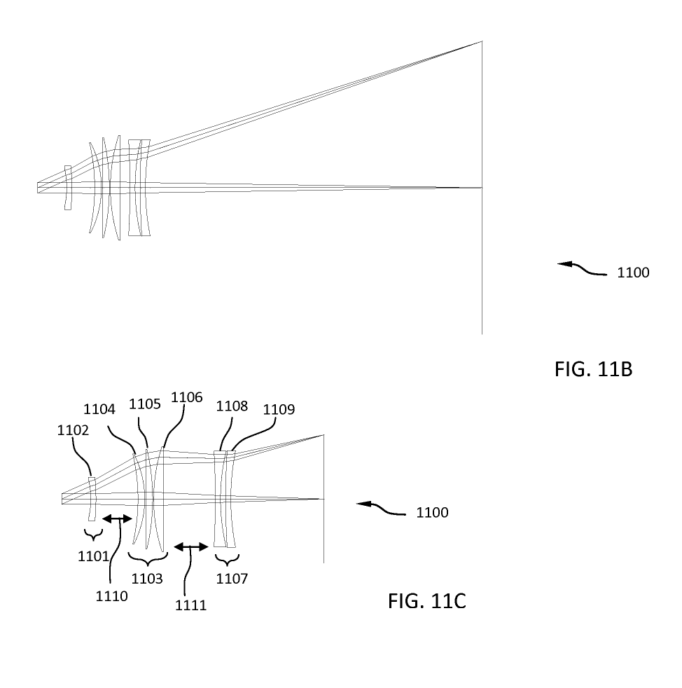

In one embodiment, a six element VF³ lens 1100 having a focal length range of 150 mm to 450 mm at 1064 nm with a 10 mm input aperture is shown with different focal length configurations in FIGS. 11A-11C. Referring to FIG. 11C, from the input surface to the output surface, VF³ lens 1100 comprises three lens groups. A first lens group 1101 is a single N-SF6 fixed element 1102 concave toward the input having negative optical power. A second lens group 1103 comprises multiple N-SF6 elements 1104, 1105, and 1106, each element having positive optical power, the second group configured to be adjusted along the optical axis. A third group 1107 comprises two elements, N-SF6 element 1108, and N-BK7 element 1109 each having negative optical power, the third group configured to be adjusted along the optical axis. Motion of the third group 1107 away from the first group decreases focal length of the VF³ lens. Motion of the second group 1103 provides well-corrected optical aberrations over a wide focal length adjustment range. Preferably, the second group comprises three optical elements. The focus range may be approximately 295 mm and the square field size may be 93 mm to 294 mm.

High index optical glasses, for example N-SF6 may be used for positive optical elements to minimize optical aberrations, minimize number of elements used and maximize the focal length adjustment range. One or more negative elements may be low index optical glass, also to help minimize optical aberrations. Glass selection may be impacted by element cost, with a lower index material such as BK7 selected for low cost. In high power laser embodiments, damage resistant material such as fused silica can be used for all elements. In achromatized designs, special consideration is given to glass dispersion, for example lower dispersion glass may used for positive elements, high dispersion in one or more negative elements. In apochromatic designs an anomalous dispersion glass may be used for improved correction.

### VF³ Based Lens Configuration and Assembly

In at least one embodiment of a VF³ based lens assembly process, VF³ lens groups are spaced apart based on a predetermined focal length and are rigidly mounted in a structure such as lens housing or lens barrel. In this case, a set of VF³ optical elements is fabricated prior to determination of the lens focal length. For example, referring again to FIG. 11, elements 1102 1104, 1105, 1106, 1108 and 1109 are fabricated before focal length is determined. Additionally, mechanical components such as lens group cells and the lens barrel or housing may also be fabricated prior to determining the lens focal length. When the lens focal length is determined, fixed values of one or more optical spacings such as spacings 1110 and 1111 are determined accordingly. Based on the one or more determined spacings, precision spacers or other mechanical configuration elements are fabricated, selected or set according to the desired focal length. The lens elements, mechanical parts and mechanical configuration components are then used in final assembly of the lens to configure the VF³ lens to the desired focal length.

Spacers may be selected from a stock of different sized spacers, designed for a range of finished lens focal lengths. Spacers may be machined as needed for a precise focal length to match a discrete determined focal length. The lens may be assembled by mounting all optical elements using the focal length specific spacers to set the focal length, or the lens may be assembled by stacking pre-assembled lens group cells with the focal length specific spacers to locate lens group positions. Assembled lens group cells may be located using other configuration components such as set screws, clamps or bonding materials to fix each lens group at a position corresponding to the determined focal length.

There are numerous benefits to building fixed lenses using a VF³ based process. Customized scanning objectives with unique focal lengths can be configured and assembled very quickly eliminating much of the long lead time generally associated with custom lens builds. For example, lead time might be 12 to 20 weeks to procure glass stock, generate lens shapes, grind, polish, edge, and coat elements. In contrast, using a VF³ based process, a customized lens can be completed in a matter days using prefabricated long lead parts with short turnaround customizing parts or customizing assembly techniques.

Not only does this process dramatically reduce lead time, but it makes low volume custom focal lengths more affordable. This is because VF³ lens elements can be fabricated in quantity to achieve cost reduction and yet be assembled in small batches or even single customized units at unique focal lengths within the designed range of a VF³ lens. While a VF³ lens element set may be more complex than a fixed focal length design, the economy of scale with batch element fabrication may offset the costs associated with so called one-up single lens manufacturing, or the added expense to fabricate a small batch of lenses as may be required to achieve laser quality lens surface figure when only a single unit is required.

In some cases, lens focal length may be determined very late in a development cycle based on applications work with a particular laser process. For example, an adjustable VF³ lens is used for the applications work to determine a desirable focal length. Then, a fixed version is built and “tuned” with lens spacings according to the determined focal length for long term use in the laser processing system. This fixed VF³ can be retuned at a later time for a different focal by re-spacing the lens elements. In another example, a settable VF³ lens is used for applications work to determine a desirable focal length and then lens groups are fixed at the desired focal length. In this example, auxiliary adjusters may be used to set lens group position prior to engaging set screws or applying bonding material or other attachment means to fix lens group positions and lens focal length.

A fixed embodiment of a VF³ lens may have advantages relative to an adjustable VF³ lens with regard to system precision by way of mechanical stability and elimination of potential focal length setting and repeatability errors. Moreover, a fixed version will have reduced part cost, complexity, and performance testing requirements. Adjustable VF³ lens embodiments may be provided with locking mechanics to temporarily fix focal length for improved accuracy and stability.

### Adjustable VF³ Lenses

With regard to adjustable focal length embodiments, each adjustable VF³ lens has one or more moveable lens group and motion (e.g. axial sliding) may be actuated with mechanical cams, rotary actuations or other lens adjustment devices. Motion of one or more moveable lens groups may be achieved with linear guides, screws threads, helicoids, recirculating bearings, ball screws, air bearings, flexure mounts or other techniques. Lens group motion may be non-linear with respect to VF³ focal length. Actuation can be manual, preferably with a single actuator, motorized with a single motor or motorized with multiple motors to move respective lens groups.

With multiple independent actuations, motion of different lens groups may be coordinated with discrete motion stops, scale markings and the like. Preferably, separate actuations are motor driven to commanded positions and lens group motion is controlled by a microcontroller or microcomputer. For example, non-linear motion of each group is controlled by independent linear stages with motion control commands generated in a motion controller. With independent lens group motion drives, axial alignment of lens group position and motion profile calibration is possible. Calibration could be used for example to compensate for variation of optical element focal lengths resulting from mechanical variations or thermal drifts.

Preferably a VF³ lens allows quick change of lens focal length from a first setting to a second setting. Preferably, lens groups are non-rotating, but rotating lens groups are within the scope of the present disclosure. While the particular mechanism is to be commensurate with the tolerance sensitivity of a particular design to provide suitable performance, the actual mechanism type is not seen as limiting with regard to variable focus flat-field objectives.

Motorized VF³ lens actuation is preferably electrically powered, but pneumatic and hydraulic power is possible. Linear or rotary motors are possible depending on the mechanism type. Multiple lens groups may be mechanically linked and driven with a single actuation or may move independently with separate actuation for each moving group. Motors, associated hardware, drive electronics and a motion control interface may be housed in a VF³ lens or in a VF³ based beam positioning subsystem.

In addition to motor drive electronics, a motorized VF³ lens may include electronics for full motion control of lens actuation. Motion control electronics may include an embedded controller and signal interface and may be responsive to input signals corresponding to a commanded lens focal length. The embedded VF³ lens controller may generate positioning signals to drive at least one motor and set the VF³ lens to a desired focal length. The embedded controller may include one or more microcontrollers programmed to receive analog or digital focal length command signals and generate respective lens group positioning signals corresponding to the commanded focal lengths.

Various aspects of VF³ lenses may interface with scan control electronics. The VF³ lens may include one or more sensor elements to provide lens status and error data, for example lens group position, lens focal length, lens temperature, motion limit sense, ready to process, calibration required, active lasing, or laser power. The VF³ lens may further provide field status or error data, for example target recognition, target alignment, or processing status. The VF³ lens may communicate lens data or field data to scan head control electronics or to a laser processing system controller.

A computer readable memory may be housed in the VF³ lens and may contain data specific to the lens, such as an identification number, date of manufacture, component source data, test data, calibration data, runtime history data, or service history data. The memory may receive and store processing history data, part serialization data or processing job parameters.

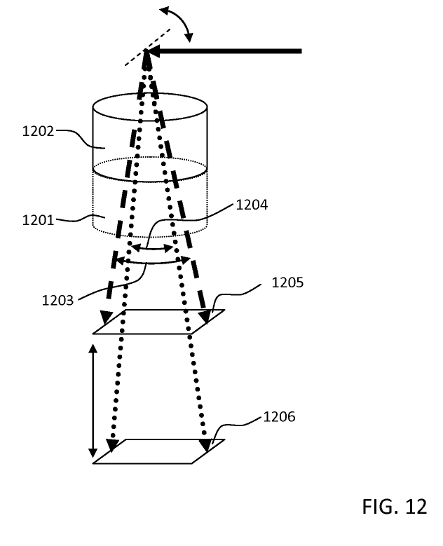

When VF³ lens focal length is adjusted, the scan field size changes proportional to the focal length, for example as previous discussed regarding FIG. 4. Likewise, within the scan field, absolute laser spot position in the scan field (relative to the optical axis of the VF³ lens) will change proportional to focal length. To maintain a field position when VF³ lens focal length is adjusted, scan angle correction is needed. As illustrated schematically in FIG. 12, a first VF³ lens focal length setting 1201 is adjusted to a second focal length setting 1202 and scanning angles 1203 are scaled down to modified scanning angles 1204. The modified angles correlate commanded positions in reference field 1205 with focused positions in focus adjusted field 1206. Note, scan angles 1203 and 1204 are schematic extensions of the VF³ lens beam angle inputs for illustrative purposes of field positions and do not represent actual VF³ lens output beam axis angles.

In at least one embodiment, a VF³ lens controller is configured to communicate with a scan head or with galvanometer drivers to control laser scanning. The VF³ lens controller generates and transmits galvanometer positioning signals that correspond with an adjusted focal length setting of the of the VF³ lens. The VF³ lens controller may be configured to transform scan field coordinates from a nominal focal length field coordinate system to coordinates in a field corresponding with the adjusted lens focal length setting to process material at predetermined coordinates in the scan field of the adjusted lens. Scanning control may be independent from lens actuation, for example scanning control may be provided in a manually actuated VF³ lens (i.e. with no motion control) such that field coordinates are transformed according to a manual lens setting.

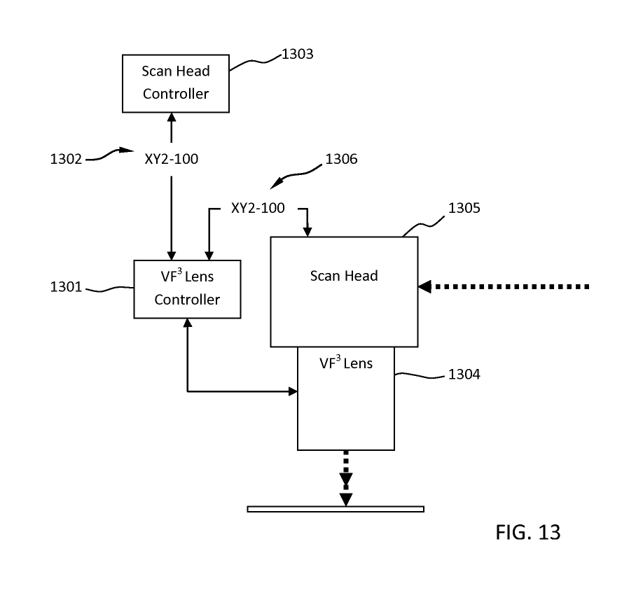

In this way, a VF³ lens controller can correct scaling errors introduced by focal length adjustments and focal length can be adjusted independently from scan job creation. For example, referring to FIG. 13, VF³ lens controller 1301 receives scan data via XY2-100 protocol 1302 from scan head controller 1303. VF³ lens controller 1301 reads the data, transforms the data based on the adjusted focal length setting of VF³ lens 1304 and a reference value, and transmits corrected data to the scan head 1305 via XY2-100 protocol 1306. The reference value may be a predetermined focal length value, a maximum or minimum focal length value, or a value associated with a scan job such as a z-axis command transmitted to the VF³ lens controller via XY2-100 protocol.

Embodiments with scale correction can be used to replace a fixed focal length lens with a VF³ lens, passing the XY2-100 protocol interface though the VF³ lens controller using existing scan control hardware. The VF³ lens controller may also receive and transmit laser control signals to synchronize corrected scanning commands with laser output. When scanning commands are passed through a VF³ lens controller, some latency may result. Scan delay parameters may be adjusted using host laser timing or laser timing may be delayed or generated in the VF³ lens controller.

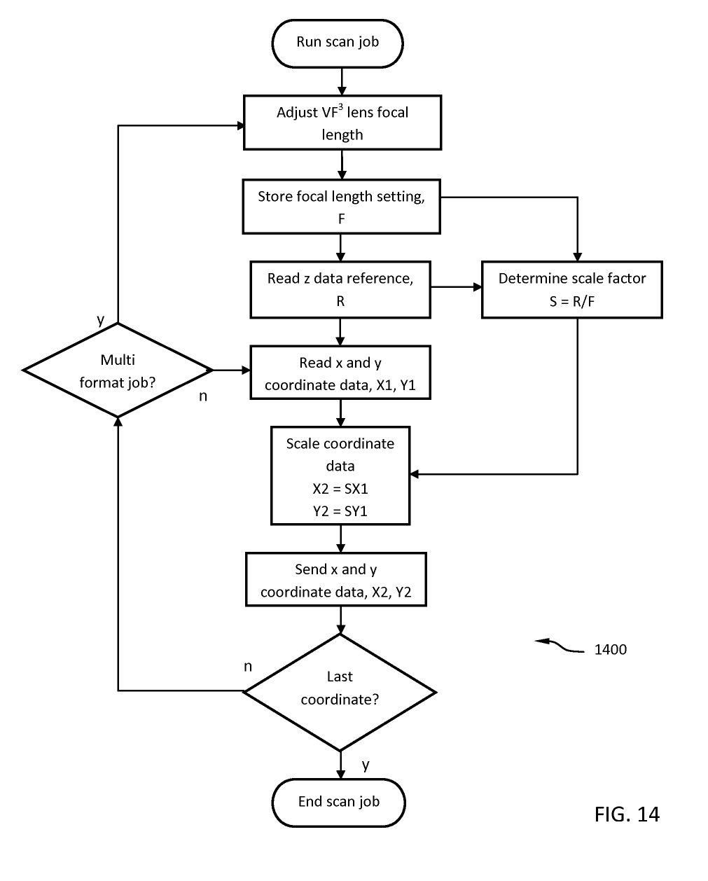

A scaling routine 1400 is shown in the flow diagram of FIG. 14. A scan job is run, a VF³ lens is adjusted to a focal length, the focal length setting is stored, the controller reads Z reference data, reads X and Y scan coordinate data, determines a scaling factor based on the ratio of the reference to the stored focal length setting, applies scaling to the coordinate data, and sends scale corrected scanning commands to the scan head. In a multi-format scan job, multiple reference values may be read and used to determine multiple respective scale factors.

When high accuracy scanning is desired, position scale alone may not be sufficient to provide fully corrected scanning commands. For example, scan linearity of the VF³ lens may vary slightly as focal length changes. A linearization table (e.g. correction grid) or a coordinate transform algorithm may be used in conjunction with focal length scaling for increased accuracy.

### VF³ Lens Based Beam Positioning Systems

Laser scan heads are available from several galvanometer manufacturers including Cambridge Technology, Scanlab, and Nutfield Technology. These scan heads have suitable aperture sizes (e.g. 7, 10, 14, and 20 mm) with mirrors coated for one or more laser wavelengths including 1064 nm, 532 nm and 355 nm that may be used in laser processing applications. In some configurations, the scan head has a mechanical interface to allow for lens mounting directly to the scan head (e.g. block type) while in other configurations the scan head is mounted into a subsystem (e.g. bracket type) and the subsystem has a mechanical interface for the lens. The mechanical lens mounting interface can be for example, a threaded mount, mounting flange, bayonet or other mounting feature. In any case, the interface is used for lens mounting relative to the positions of scanning mirrors forming a beam positioning subsystem.

A VF³ lens can be used with these and other scan heads in a beam positioning subsystem that provides beam deflection and flat-field focusing. A mounted VF³ lens extends from the scan head toward the work surface. Now, considering a footprint volume that includes the scan head, scan lens, and scan field, a VF³ lens provides a relatively compact beam positioning subsystem. In contrast, many post-objective optical systems extend away from the scan head input between the laser and the scan head. This location adds optical path length and this adds significantly to the beam positioning system footprint volume. As a result, the footprint of a VF³ lens based subsystem will generally be smaller than the footprint of a post-objective scan system.

In one VF³ based subsystem embodiment, a VF³ lens is configured as a component with a mounting feature and is mounted directly to a scan head. For example the VF³ lens might utilize an M85 mounting thread that is commonly used in commercial f-theta lenses. In this way the VF³ lens complements readily available scanning components used in laser positioning subsystems and may be used in place of standard f-theta lenses with little or no modifications.

In another subsystem embodiment, a VF³ lens is mounted into a subsystem structure along with a scan head such as an open frame scan head. A lens mount feature of the subsystem structure allows the lens to be dismounted, and can for example be used to remove the VF³ lens for system reconfiguration, maintenance and service. Likewise, the scan head can be dismounted from the subsystem structure.

In yet another subsystem embodiment of a VF³ based subsystem, a VF³ lens structure is configured to receive galvos. For example an open frame scan head may mount to the structure of the VF³ lens, individual galvo mounts may mount to the structure of the VF³ lens or individual galvos may be mounted directly to the VF³ lens structure. In each of these scenarios, the lens structure is integral to the subsystem and the lens is not dismounted as a standalone component.

VF³ based subsystem embodiments may include scan head control electronics such as electronics commercially available from the galvanometer suppliers previously mentioned. The control electronics may comprise a digital or analog servo driver for each galvanometer and a control command interface (e.g. serial input, 16 bit DAC output) using an access protocol such as a serial or parallel data bus to receive command signals, generate galvo driver inputs and return status signals. One digital protocol used to control scan heads via a serial bus is the XY2-100 protocol. Data transfer protocols with sufficient bandwidth to drive a scan may have data transfer rates of 100 kHz or higher. While digital command signals are preferred, analog signals may be received directly as galvo servo inputs.

A scan controller, generally associated with a scan head, generates scan command signals and may be a host computer, embedded computer, microcontroller or FPGA configured to generate scan control signals. The scan control signals may provide angular galvo coordinates, timing for galvo motion, and may provide laser control signals coordinated with galvo motion. In a VF³ based subsystem, the VF³ lens controller may comprise an embedded microcomputer configured to function as a scan controller.

As a scan controller, the VF³ lens controller may be configured to store and run scan jobs, and transmit positioning commands to the scan head. For example, scan jobs may be uploaded via XY2-100 protocol or other serial link which may be wired or wireless data links to the VF³ lens controller from a scan head controller or from a host computer. The VF³ lens controller may store one or more scan jobs in memory and stored jobs may be run on command from the VF³ lens controller. VF³ lens memory may include a fixed memory device or a removable memory device (depicted at 605 of FIG. 6) such as a micro sd flash card loaded with one or more stored readable scan jobs.

A VF³ lens controller may be configured to communicate wired or wirelessly with a user interface for direct control of VF³ lens features such as setting VF³ lens focal length and the VF³ lens features may include creation of scan jobs in an embedded VF³ lens microcomputer. For example, a USB port (see 606 in FIG. 6), a wireless port or other external data port associated with the VF³ lens may interface the VF³ lens micro computer with an external graphical output display and user controlled input device. USB power or power supply connectivity may be used to provide operating voltages to the VF³ lens controller. A host computer, tablet or handheld device may run a VF³ lens application, communicate with a VF³ lens, and provide graphical output display from and user controlled input to a VF³ lens controller. A controller may be housed separately or remotely from VF³ lens optics, and may provide isolation from sensitive galvanometer electronics.

A VF³ lens or subsystem may be transferred from one processing system to another processing system to move a VF³ lens based process from one processing system to another or from one processing line to another. Moving the lens from line to line may for example maintain process throughput during maintenance of a system or processing line. When a VF³ lens is configured with a readable memory, the readable memory may contain processing jobs associated with multiple systems or processing lines. Moving the lens may associate a stored processing job with a respective system or line. When processing jobs are stored on a removable memory card, jobs may be transferred from one VF³ lens to another by transferring the memory card.

### Distance Sensing

VF³ based subsystem embodiments may include features for measuring, calculating or otherwise determining workpiece distance. Based on the workpiece distance, the VF³ lens can be adjusted to focus according to the workpiece height. Preferably, adjustment is automated to achieve auto focusing, but manual focal length adjustment to a setting prescribed by workpiece distance may be used.

The workpiece distance may be communicated to host computer software to generate a scan job based on the lens adjustment setting or the distance may be used by a VF³ lens subsystem controller or a scan controller to modify a preexisting scan job. In the former case, scan field coordinates can be calculated using the current focal length setting. In the later case, scale factors can be determined and applied to existing scan job coordinates. As previously discussed, a VF³ controller may scale nominal scanning commands based on a set VF³ lens focal length. In yet another case, scale factors corresponding to focal length can be applied without recalculating coordinates by resetting the angular output scale in each servo driver to directly attenuate galvo scan angles.

The workpiece distance may be determined from a single field point or multiple field points. A single point may be used to set focus of a planar surface that is parallel to the focal plane of the VF³ lens. Multiple points may be used to determine distance and orientation of a planar surface, orientation of a known surface topography, or topography of an unknown surface.

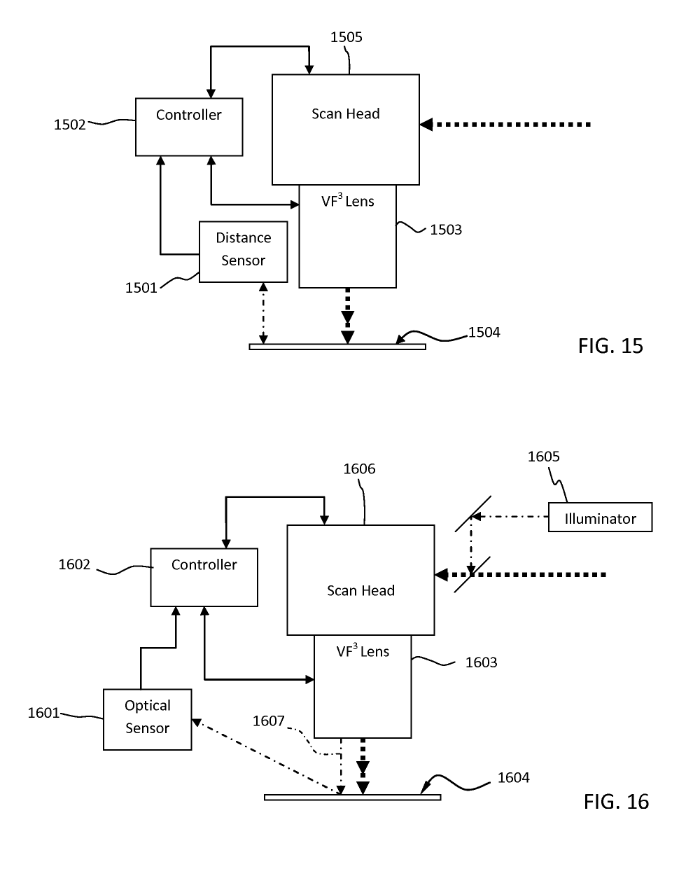

In at least one embodiment a distance sensor external to the VF³ lens optical path and responsive to external stimuli is used. Referring to FIG. 15, a distance sensor 1501, for example a camera system, laser triangulation system, laser ranging system, ultrasonic distance sensor or other distance sensor provides a distance signal to controller 1502 of the VF³ lens subsystem. VF³ lens 1503 is adjusted for focus on workpiece 1504 based on the distance signal. Workpiece distance or VF³ lens setting may be used to control scan head 1505.

In at least one embodiment a distance sensor external to the VF³ lens optical path responsive to internal stimuli is used. Referring to FIG. 16, a optical sensor 1601 provides a distance signal to controller 1602 of the VF³ lens subsystem. VF³ lens 1603 is adjusted for focus on workpiece 1604 based on the distance signal. Illuminator 1605 may be scanned by scan head 1606 to generate internal projected measurement beam 1607 for detection by the external sensor.

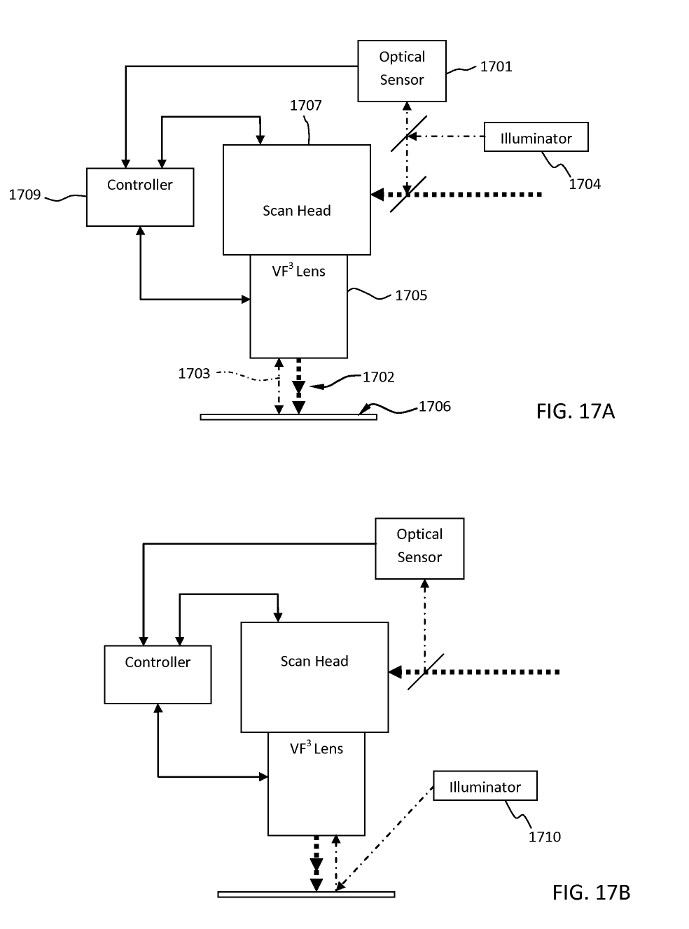

In other embodiments, light is received along the optical path of the VF³ lens and detected by an internal optical sensor to determine distance. Referring to FIG. 17A, light impinges the target field and is sensed by internal optical sensor 1701 to determine workpiece distance. For example, laser radiation 1702 from a processing laser or light 1703 from internal illuminator 1704 is projected through VF³ lens 1705 onto the workpiece 1706 by scan head 1707, reflected and sensed by the internal sensor. The scan head and VF³ lens may be controlled by controller 1709. Likewise, as shown in FIG. 17B, and external illuminator 1710 may be used in conjunction with internal sensor 1701. The internal sensor may be used, for example, for time of flight laser ranging or imaging of target features for contrast and edge based focusing. Multiple alignment targets at predetermined locations on a surface can be measured to determine scanned field scale, orientation, and focus distance.

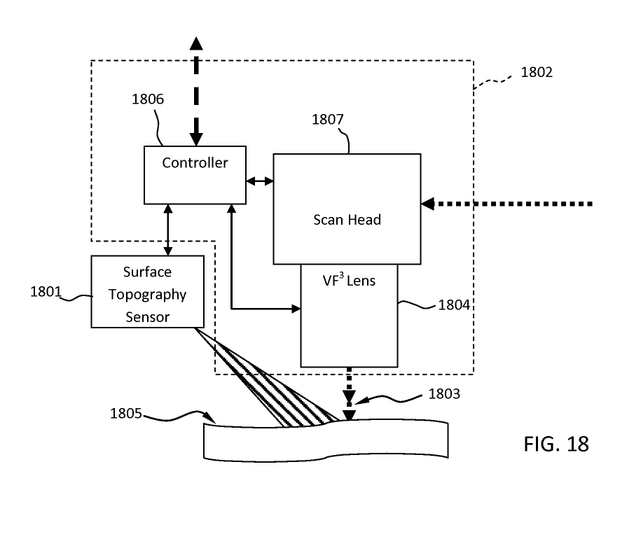

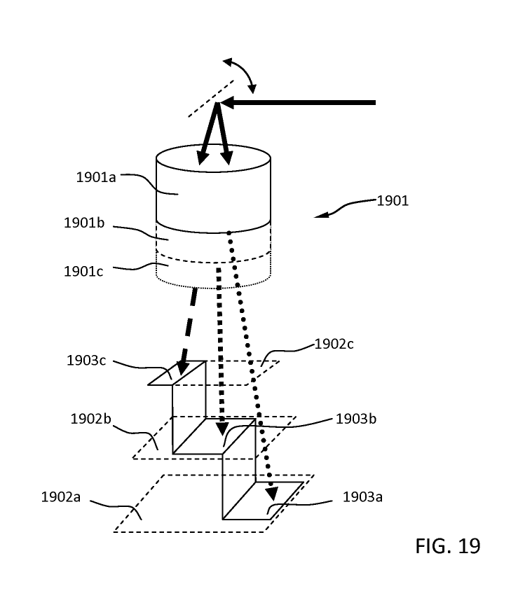

Referring to FIG. 18, one or more 3-D surface topography sensor 1801 may be used to acquire 3-D target surface topography information and transmit data corresponding to focus distance to the VF³ subsystem 1802. Focus distance 1803 of VF³ lens 1804 may be adjusted to process material based on the topographic surface data of substrate surface 1805. When 3-D surfaces are processed, automated focus commands may be transmitted to the VF³ lens controller 1806 using the XY2-100 protocol or other 3-D scanning control protocol. 3-D geometric correction of the scan field scanned by scan head 1807 can be used to account for scale variation with height.

Distance sensing can be used for static adjustment to set-up a processing job at a single height or to accommodate multiple workpieces with height differences. Distance sensing can also be used for dynamic adjustment, for example, to track height of a moving workpiece or height variation over a workpiece. With different surface heights, spot size correction may be employed for uniform processing with a consistent spot size. When focus height is changed during a scan job, trajectory planning in scan job creation may take into account the maximum VF³ lens focus slew rate to ensure focus fidelity.

In one example, shown in FIG. 19, VF³ lens 1901 is adjusted to multiple settings 1901a, 1901b, 1901c to focus on one or more respective focus steps 1902a, 1902b, 1902c to process material 1903a, 1903b, 1903c at each respective adjusted step. For continuous surfaces, topographic data may be parsed into discreet focus steps based on available spot depth of focus. Within each step, topographic data can be used for geometric correction of spot position errors resulting from height differences.

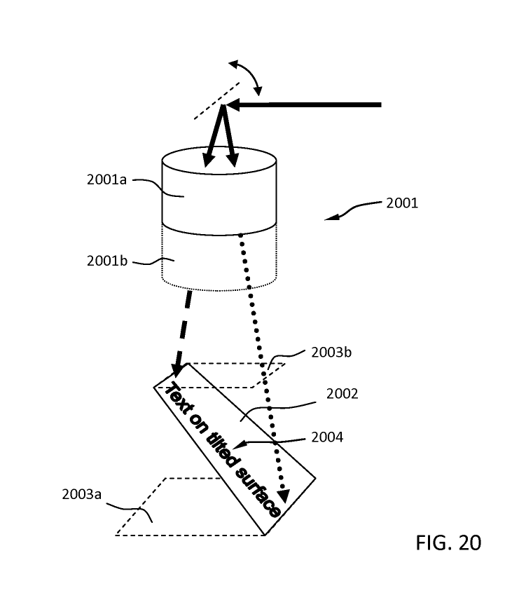

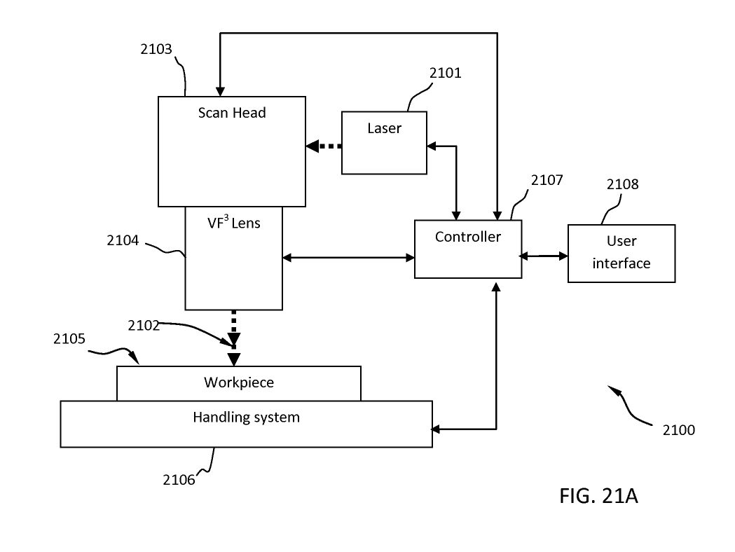

Sensed or predetermined topographic data may be used to establish a tilted surface. For example, as shown in FIG. 20, VF³ lens 2001 is adjusted through a range of settings from 2001a, to 2001b to automatically track height of the tilted surface 2002 from focus step 2003a, through 2003b. While VF³ lens focus adjustment may be slower than galvanometer based post objective dynamic focusing, VF³ lens speed may be adequate in many applications and VF³ lens focus range can provide large focus depth. For example, focus tracking may be used in raster scanning of a tilted surface when the slow axis corresponds with the surface gradient, or in tracking focus of a text string 2004 on a tilted surface.

### VF³ Based Processing

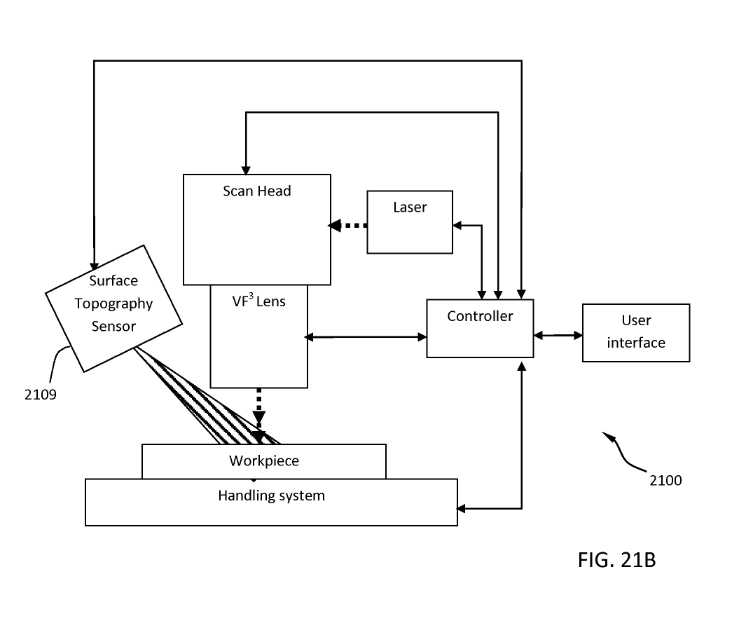

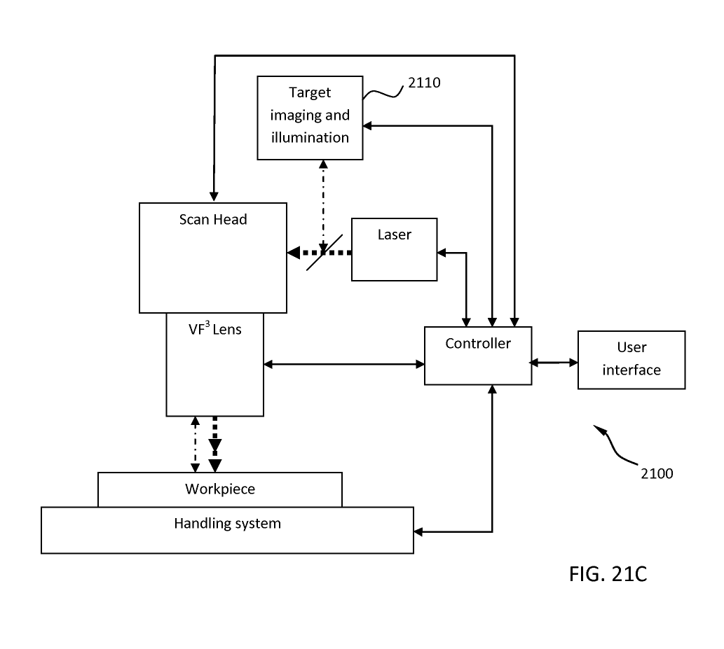

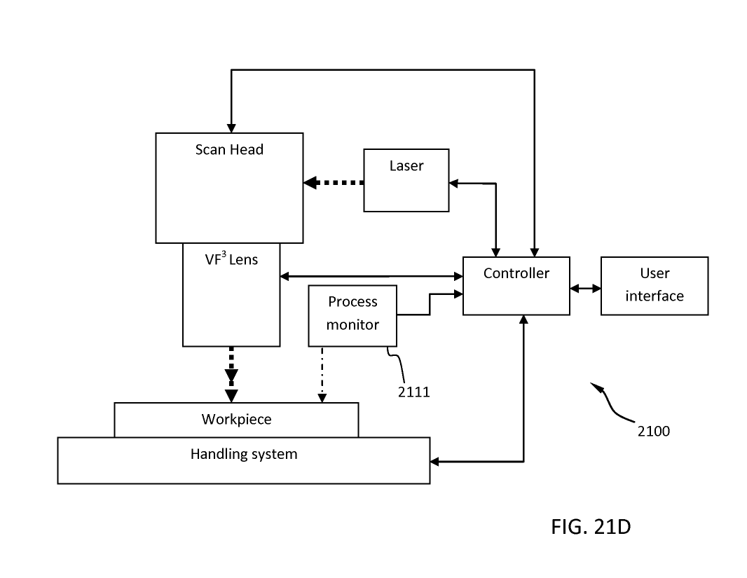

In at least one embodiment, referring to FIG. 21A, a VF³ based processing system 2100 includes a processing laser 2101 that generates a processing beam 2102, a scan head 2103 to deflect the processing beam, a VF³ lens 2104 to direct and focus the processing beam to target material of a workpiece 2105, a material handling system 2106 to locate workpieces in the processing scan field, and a system controller 2107 to coordinate the processing laser, the scan head, the VF³ lens, and material handling, and a user interface 2108 to set up and run processing jobs. Many aspects of VF³ lenses and VF³ basis subsystems can be used in VF³ lens based processing systems to provide advantages including a simplified system architecture that provides fine focusing capability, multi-format processing, and variable height processing.

VF³ based system 2100 may include additional features, for example as shown in FIG. 21B, topography sensor 2109, as shown in FIG. 21C target imaging and illumination components 2110, and as shown in FIG. 21D a process monitor 2111. Topography sensing and target imaging and may generate control signals for part detection, part alignment, focal length setting, scan field alignment and scan field calibration. Process monitoring features may provide feedback signals to the laser processing system including workpiece height, workpiece placement verification and laser process verification. System 2100 may also include laser detection components for example an embedded VF³ lens photo detector may provide laser emission confirmation signals, laser fault signals, laser beam property signals, scanning confirmation signals and scanning fault detection signals.

VF³ lens based system fine focusing is advantageous in processing jobs requiring part height variation. When fixed focal length objectives are used, focusing options include using material handling to moving the entire workpiece into the focal plane of the processing scan field, moving part of the laser processing system to move a mounted fixed lens relative to the work surface to bring the lens focal plane to the work surface, or adjusting an upstream beam expander to make small shifts in the focal plane. In a VF³ lens based system, material handling can remain stationary since the focal plane can be moved relative to the target surface with appropriate adjustment of the VF³ lens. Likewise, no part of the laser processing system needs to move relative to the workpiece for focusing. It will be appreciated that eliminating staging needed for moving either the target surface or the beam delivery system provides a simplified system configuration and can reduce the overall system footprint.

Use of a VF³ lens further simplifies the processing system by minimizing the need to adjust the collimation of the beam into the scan head. The VF³ lens based system can maintain a set collimation and a fixed optical axis into the scan head regardless of workpiece focus height. This can eliminate decollimation focus problems such as field curvature that may be introduced at the work surface, beam diameter errors at the scan head and beam pointing errors when optical elements are moved.

Changing VF³ lens focal length will generally change the imaged spot size and the maximum scan field size. For minor focal length changes associated with flat-field fine focus adjustments, for example adjustments of several millimeters, laser spot size changes and field size changes will be small. For example, 3 mm of focus adjustment at a nominal 160 mm focal length would change the spot size and field size proportional to the relative change in focal length, about 2%. This spot size change may be negligible for many processing applications.

The small field scale error resulting from fine focus adjustment may be also be acceptable in some applications, but fine positioning accuracy can be maintained by applying scan field scale correction as previously discussed, for example correction to scan field positioning commands based on relative focal length settings.

When a VF³ lens has a substantial focal length adjustment range as previously discussed, the VF³ lenses can provide multi-format processing, which can be in used in a processing system in conjunction with system work height adjustment. As the focal length of the VF³ lens is changed to change the processing system format, the workpiece height is adjusted accordingly by the material handling system. The adjustment may be accomplished before processing during job set-up or may be made during processing such that different formats are used for processing from one job to another, or within a single processing job. For example, format changes may be used to change the nominal field size and spot size for different workpieces or may accommodate different height surfaces or steps of a single workpiece.

Use of VF³ lens adjustment in conjunction with system work height adjustment for spot size adjustment has advantages over other spot size changing techniques. Spot size can be changed while the input beam diameter and scan head fill are fixed. This is in contrast to using an auxiliary variable magnification beam expander for spot enlargement where the input beam diameter is reduced and scan head fill changes. Also, in contrast to defocus techniques, VF³ lens spot size can be changed and maintain depth of focus by using the Gaussian beam waist at focus. With VF³ lens spot size adjustment techniques, the maximum scan field size without field scaling will be larger than either the variable beam expander or defocus techniques since the field size increases with focal length as the spot size increases.

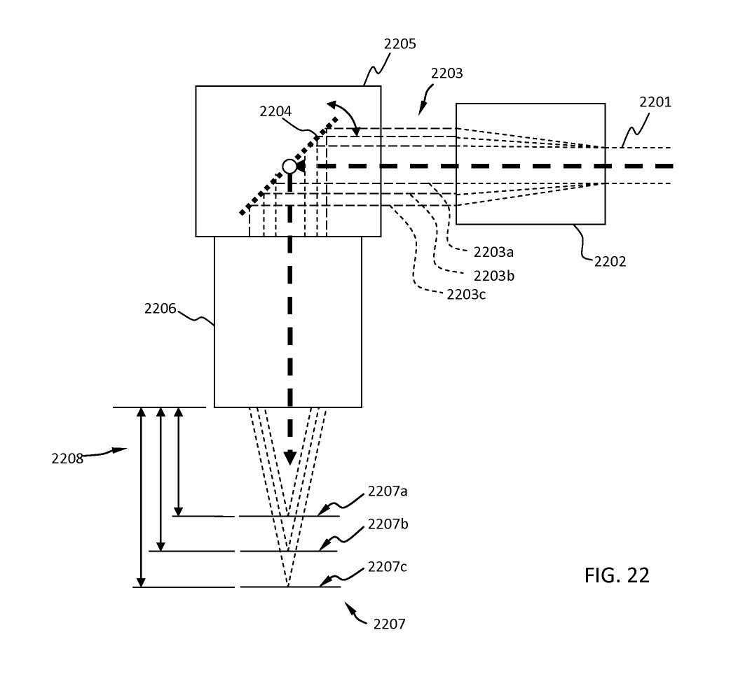

When workpiece height varies and constant spot size is needed, spot size correction techniques can be implemented in a VF³ based subsystem or system by adjusting the beam diameter that is input to the scan head. In this way, large focal length changes can be accommodated while maintaining uniform spot size. In one spot size control example shown in FIG. 22, the diameter of input beam 2201 is expanded by variable beam expander 2202 and expanded beam 2203 is deflected by scan mirrors 2204 in scan head 2205. The deflected beam is focused by VF³ lens 2206 to workpiece surface 2207 in a range of focus distances 2208. For spot size control, the expanded beam diameter settings 2203a, 2203b, and 2203c maintain a constant external f/number to maintain a constant focused spot size at respective workpiece surface heights 2207a, 2207b, and 2207c.

Various techniques can be used to control the beam diameter at the scan head including automated motorized zoom beam expanders. Alternatively, spot defocus and other spot enlargement techniques may be used in some cases for spot size control. Generally, constant spot diameter is desired, but other spot metrics such as uniform peak fluence or constant spot area (e. g. when spot shape is non-round) are possible.

VF³ based systems may include a user interface responsive to processing lens focal length adjustment inputs. For example the user may remotely select a desired focal length setting within the range of the system VF³ lens by interacting with the user interface. Based on the user selection, the system controller drives the lens VF³ lens to configure the lens at the selected focal length and format the system accordingly. Selection of VF³ lens focal length may set automatically by a processing job parameter or based on measurement of target material. For example, a marking system might be automatically reconfigured based on overall size of target material to be marked or size of a desired mark area.

As part of a laser processing system, a VF³ lens can be implemented with manual or motorized actuation. When actuation is manual, adjustments can be made by accessing the lens, for example direct access to a lens that may be inside a processing chamber. Preferably, actuator access is located outside of the laser beam path covers, that is so say beam path covers from the laser to the VF³ lens (e.g. actuator access is on the lens barrel). Thus the beam path covers would not need to be opened, maintaining system cleanliness and thermal stability as well as improved laser safety.

A system may also be configured so that mechanical adjustment of the VF³ lens can be made without accessing a laser processing chamber. In this case manual adjustment can be made safely without access to the laser processing field. For example a VF³ lens can be used in conjunction with a class 1 safety enclosure and VF³ lens adjustment is made in a class 1 environment. This allows the user to safely perform VF³ lens adjustment during processing, for example setting laser focus on a fixed height workpiece while running a scanned laser spot focusing routine or readjust a focus setting manually over the course of a processing job.

### Volumetric Processing

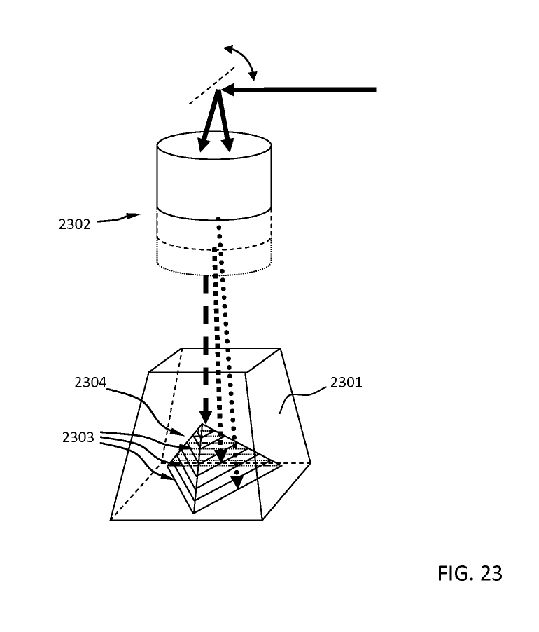

Now with regard to some three dimensional aspects of VF³ based scanning and referring to FIG. 23, the angular scan field and focal distance range of VF³ lenses determines an addressable scan volume that is essentially a truncated pyramid shape 2301 when the scan field is square. Volumetric scanning of objects is possible within this shape on a layer by layer basis by incrementing the focal length adjustment of VF³ lens 2302, for example layers 2303 of tetrahedron 2304. This type of processing might be used for example in an additive manufacturing process adding layers of photopolymer, sintering materials, fuseable materials or other materials by laser interaction to a stationary article. With volumetric processing it may be desirable to control spot size by adjusting the beam diameter as discussed above. For example, at any processing layer within the processing volume, an adjusted beam diameter can be used to equalize the spot size from the bottom to the top of the processing volume.

Thus, specific compositions and methods of variable focus flat-field scanning have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A variable focus flat-field (VF³) lens configured to receive an angularly scanned laser beam and focus the scanned laser beam in a focal plane at one or more a focus heights in a range of focus heights, the VF³ lens comprising:
an entrance pupil accommodating a scanned input beam,
a focal plane,
an optical axis extending from the entrance pupil to the focal plane,
multiple lens elements disposed along the optical axis,
at least one configurable lens element group comprising one or more of the multiple lens elements, and
lens element mounting structure comprising respective mounting surfaces for the multiple lens elements to locate each lens element along the optical axis corresponding to a focal length and a focus height, the mounting surfaces comprising at least one configurable mounting surface to locate a respective configurable lens element group at one or more locations corresponding to one or more respective configured focal lengths and focus heights in a range of configurable focal lengths and associated focus heights.

2. The VF³ lens as in claim 1, wherein the at least one configurable mounting surface is at least one fixed surface to locate a respective configurable lens element group at a first location corresponding to a first configured focal length.

3. The VF³ lens as in claim 1, wherein the at least one configurable mounting surface is at least one settable mounting surface set to locate a respective configurable lens element group at a location corresponding to a configurable focal length.

4. The VF³ lens as in claim 1, wherein the at least one configurable mounting surface is at least one adjustable mounting surface adjusted to locate a respective configurable lens element group at a location corresponding to a configurable focal length.

5. The VF³ lens as in claim 4, further comprising means for adjusting the at least one adjustable mounting surface to locate a respective configurable lens element group at multiple locations corresponding to multiple configurable focal lengths.

6. The VF³ lens as in claim 1, comprising a first lens group having negative optical power, a second lens group having positive optical power, and a third group having negative optical power, wherein the third group is a configurable lens element group, whereby an increase in distance along the optical axis from the entrance pupil to the third group corresponds to a decrease in focal length of the VF³ lens.

7. The VF³ lens as in claim 6, wherein the second lens group is a configurable lens element group with an axial location associated with the axial location of the third lens element group.

8. The VF³ lens as in claim 1, further comprising a control signal interface for transmitting at least one control signal.

9. The VF³ lens as in claim 1, further comprising a control signal interface for receiving at least one control signal.

10. The VF³ lens as in claim 1, wherein the multiple lens elements disposed along the optical axis focus the scanned laser with less than 0.07 waves of RMS OPD.

11. The VF³ lens as in claim 1, further comprising a controller responsive an input signal corresponding to configurable focal length values, the controller configured to adjust the focal length of the VF³ lens to a configurable focal length value based on the input signal.

12. The VF³ lens as in claim 1, wherein the scanned beam has a first wavelength, the VF³ lens further configured to receive an auxiliary scanned beam having a second wavelength distinct from the first wavelength, and focus the auxiliary scanned beam in a focal plane at one or more a focus heights in a range of focus heights, respective locations of the multiple lens elements at the first and second wavelengths focusing the first and second wavelength at one or more common focus height.

13. A VF³ lens based beam directing system comprising:
one or more beam deflectors configured to receive an input beam and deflect the input at scan angles corresponding to locations in a scan field,
a VF³ lens configured to receive the scanned input beam and focus the beam in a scan field at an adjustable focus height setting, and
a controller configured to generate scanning commands to direct the scanned beam to predetermined points in the scan field.

14. The VF³ lens based beam directing system as in claim 13, wherein the controller is responsive to VF³ lens adjustments and configured to output scanning commands that direct the scanned beam to predetermined points in the scan field at multiple focus height settings.

15. In a VF³ lens based laser processing system comprising a laser source, a beam deflector responsive to scanning commands, a VF³ lens, and a material handling system for locating a workpiece relative to a laser processing scan field, the VF³ lens having a configurable focal length that is adjustable within a configurable range of focal lengths to provide an adjustable focus height laser processing scan field, a laser processing method comprising:
adjusting the VF³ lens focal length to a first focal length in the configurable range of focal lengths, and
processing material in the scan field at a first focus height associated with the first focal length.

16. The method as in claim 15, further comprising adjusting the VF³ lens focal length to a second focal length and processing material at a second focus height associated with the second focal length.

17. The method as in claim as in claim 16, further comprising scaling scanning commands to correlate commanded scan field positions in the scan field at the first focus height with a scan field scan field positions in the scan field at the second focus height.

18. The method as in claim as in claim 15, further comprising adjusting the VF³ lens focal length in response to a sensor input.

19. The method as in claim as in claim 15, further comprising sequentially focusing the VF³ lens at multiple workpiece heights in an addressable scan volume and processing workpiece material at multiple heights within the scan volume.

20. The method as in claim as in claim 19, wherein processing material comprises layer by layer processing.
